(19) United States
(12) Patent Application Publication
(10) Pub. No.: US 2010/0294984 A1
(43) Pub. Date: Nov. 25, 2010

(54) METHODS OF INHIBITING SCALE OF SILICA

(75) Inventors: Wenqing Peng, Shanghai (CN); Su Lu, Shanghai (CN); Zhida Pan, Shanghai (CN); Ashok Shankar Shetty, Newtown, PA (US); Chihyu Sui, Newtown, PA (US); Bing Zhang, Shanghai (CN); Shengxia Liu, Shanghai (CN); Mingna Xiong, Shanghai (CN); Yangang Liang, Shanghai (CN)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: General Electric Company, Schenectady, NY (US)

(21) Appl. No.: 12/470,698

(22) Filed: May 22, 2009

(51) Int. Cl. C02F 5/14; C02F 5/10; C02F 5/12

(52) U.S. Cl. 252/180

(57) ABSTRACT

The invention relates to a method of controlling silica scale in an aqueous system, including adding an effective amount of mixture of a first polymer and a second polymer into the aqueous system, wherein the first polymer and the second polymer each has at least one of a first structural unit derived from any of quaternary ammonium monomer, quaternary phosphonium monomer, and quaternary sulfonium monomer and a second structural unit derived from any of sulfonic acid, sulfuric acid, phosphoric acid, carboxylic acid and any salt thereof, the first polymer bears a first net charge or being neutral, the second polymer bears a second net charge opposite the first net charge or bearing positive net charge when the first polymer is neutral, the first structural unit is from about 1 mol % to about 99 mol % of the mixture.

### BACKGROUND

The invention relates generally to inhibition of silica scale in aqueous systems, and particularly relates to methods of inhibiting scale of silica in aqueous systems.

The problem of scale formation and its attendant effects have for many years troubled aqueous systems, such as power plants, evaporative cooling systems, membrane desalination, semiconductor manufacturing, geothermal systems, boiler water, industrial process water, and water in central heating and air conditioning systems.

Silica is one of major fouling problems in aqueous systems. Silica is difficult to inhibit as it assumes low solubility forms depending on the conditions in the aqueous system.

Silica (silicon dioxide) appears naturally in a number of crystalline and amorphous forms, all of which are sparingly soluble in water; thus leading to the formation of undesirable deposits. Silicates are salts derived from silica or the silicic acids, especially orthosilicates and metasilicates, which may combine to form polysilicates. All of these, except the alkali silicates, are sparingly soluble in water. A number of different forms of silica and silicate salt deposits are possible, and formation thereof depends, among other factors, on the temperature, pH and ionic species in water. For example, at neutral pH range, 6.5 to 7.8, monomeric silica tends to polymerize to form oligomeric or colloidal silica. At high pH, for example, pH 9.5, silica can form a monomeric silicate ion. As conversion of silica into these various forms can be slow, various forms of silica can co-exist in an aqueous system at any one time, depending on the history of the system.

It is also possible for a variety of other types of scales to co-exist with silica or silicate scales in a water system.

Various methods have been utilized for resolving the problem of silica deposition. Some methods are directed to inhibit polymerization of silica and other methods focus on dispersion of colloidal silica. Some chemicals used to inhibit polymerization of silica tend to flocculate with silica, resulting in high turbidity and deposition. A very high dosage of known chemicals is usually needed for achieving an effective dispersion of colloidal silica, which makes them very difficult to commercialize from cost perspective. In addition, currently available silica scale inhibition chemicals are either pH sensitive to increase difficulties of control, or instable under certain water conditions.

Thus, there is a need in the art to control silica scale in aqueous systems in more feasible and more stable ways.

### BRIEF DESCRIPTION

In one aspect, the invention relates to a method of controlling silica scale in an aqueous system, comprising adding an effective amount of mixture of a first polymer and a second polymer into the aqueous system, wherein the first polymer and the second polymer each comprises at least one of a first structural unit derived from any of quaternary ammonium monomer, quaternary phosphonium monomer, and quaternary sulfonium monomer and a second structural unit derived from any of sulfonic acid, sulfuric acid, phosphoric acid, carboxylic acid and any salt thereof, the first polymer bears a first net charge or being neutral, the second polymer bears a second net charge opposite the first net charge or bearing positive net charge when the first polymer is neutral, the first structural unit is from about 1 mol % to about 99 mol % of the mixture.

In another aspect, the invention relates to a method of inhibiting silica scale formation in an aqueous system, said method comprising: adding an effective amount of a polymer to the aqueous system, wherein the polymer comprises: a first structural unit derived from a quaternary ammonium monomer, a quaternary phosphonium monomer, or a quaternary sulfonium monomer, the first structural unit representing from about 30 mol % to about 80 mol % of all monomer-derived structural units present in the polymer; and a second structural unit derived from a sulfonic acid, a sulfuric acid, a phosphoric acid, or a salt thereof.

### DETAILED DESCRIPTION

In one aspect, the invention relates to a method of controlling silica scale in an aqueous system, comprising adding an effective amount of mixture of a first polymer and a second polymer into the aqueous system, wherein the first polymer and the second polymer each comprises at least one of a first structural unit derived from any of quaternary ammonium monomer, quaternary phosphonium monomer, and quaternary sulfonium monomer and a second structural unit derived from any of sulfonic acid, sulfuric acid, phosphoric acid, carboxylic acid and any salt thereof, the first polymer bears a first net charge or being neutral, the second polymer bears a second net charge opposite the first net charge or bearing positive net charge when the first polymer is neutral, the first structural unit is from about 1 mol % to about 99 mol % of the mixture.

In some embodiments, the first polymer may be a cationic polyelectrolyte and the second polymer may be an anionic polyelectrolyte. In other embodiments, the first polymer may be a cationic polyelectrolyte and the second polymer may be a nonionic polymer or a combination of a nonionic polymer and an anionic polymer. In other embodiments, the first polymer may be a polyampholyte and the second polymer is a polyelectrolyte. In other embodiments, both the first and the second polymers may be polyampholytes.

In some specific embodiments, the first and the second polymers are poly(2-(methacryloyloxy)-ethyltrimethyl ammonium chloride-co-2-acrylamido-2-methylpropane sulfonic acid) and 2-(methacryloyloxy)-ethyltrimethyl ammonium chloride is from about 10 mol % to about 90 mol % of the mixture.

In some embodiments, the first polymer is poly(2-(methacryloyloxy)-ethyltrimethyl ammonium chloride-co-acrylic amide) and the second polymer is poly(2-acrylamido-2-methylpropane sulfonic acid-co-acrylic amide) and 2-(methacryloyloxy)-ethyltrimethyl ammonium chloride is from about 30 mol % to about 70 mol % of the mixture.

In some embodiments, the first polymer is poly(2-(methacryloyloxy)-ethyltrimethyl ammonium chloride-co-2-acrylamido-2-methylpropane sulfonic acid), the second polymer is selected from poly(2-acrylamido-2-methylpropane sulfonic acid), poly(acrylic acid), poly(acrylic acid-co-2-acrylamido-2-methylpropane sulfonic acid), poly(acrylic acid-co-1-allyoxy-2-hydroxy propyl sulfonate), poly(acrylic acid-co-1-allyoxy-polyethlyene oxide-sulfate-co-1-allyoxy-2-hydroxy propyl sulfonate), poly(acrylic acid-co-1-allyoxy-polyethlyene oxide-sulfate), and poly(2-acrylamido-2-methylpropane sulfonic acid-co-acrylamide), and 2-(methacryloyloxy)-ethyltrimethyl ammonium chloride is from about 10 mol % to 60 mol % of the mixture.

In some embodiments, the first polymer is poly(2-(methacryloyloxy)-ethyltrimethyl ammonium chloride), the second polymer is selected from poly(2-acrylamido-2-methylpropane sulfonic acid), poly(acrylic acid), poly(acrylic acid-co-2-acrylamido-2-methylpropane sulfonic acid), poly(acrylic acid-co-1-allyoxy-2-hydroxy propyl sulfonate), poly(acrylic acid-co-1-allyoxy-polyethlyene oxide-sulfate-co-1-allyoxy-2-hydroxy propyl sulfonate), poly(acrylic acid-co-1-allyoxy-polyethlyene oxide-sulfate), and poly(2-acrylamido-2-methylpropane sulfonic acid co-acrylamide), and 2-(methacryloyloxy)-ethyltrimethyl ammonium chloride is from about 10 mol % to about 70 mol % of the mixture.

In some embodiments, the first polymer is poly(2-(methacryloyloxy)-ethyltrimethyl ammonium chloride-co-(ethylene glycol) methyl ether methacrylate) and the second polymer is poly(2-acrylamido-2-methylpropane sulfonic acid).

In some embodiments, the first and the second polymers are added into the aqueous system simultaneously. In some embodiments, the first and the second polymers are added into the aqueous system sequentially.

Except the first and the second structural units, each of the first and the second polymers may comprise any other structural units which do not affect the performance of the mixture. Examples of the other structural units may derive from monomers, such as acrylic amide, and (ethylene glycol) methyl ether methacrylate.

In another aspect, the invention relates to a method of inhibiting silica scale formation in an aqueous system, said method comprising: adding an effective amount of a polymer to the aqueous system, wherein the polymer comprises: a first structural unit derived from a quaternary ammonium monomer, a quaternary phosphonium monomer, or a quaternary sulfonium monomer, the first structural unit representing from about 30 mol % to about 80 mol % of all monomer-derived structural units present in the polymer; and a second structural unit derived from a sulfonic acid, a sulfuric acid, a phosphoric acid, or a salt thereof.

In some embodiments, the first structural unit derives from a monomer of formula:

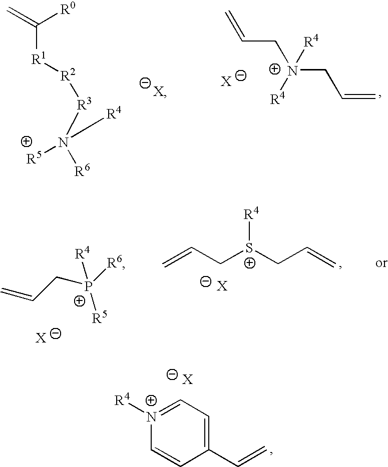

wherein R⁰ is H or an aliphatic radical; R¹ is C═O, an aromatic radical, a cycloaliphatic radical, or an aliphatic radical; R² is O, NH or an aliphatic radical; R³ is a straight or branched chain comprising 1-20 carbon atoms; R⁴, R⁵ and R⁶ are H, alkyl group comprising 1-5 carbon atoms, allyl, phenyl, cycloaliphatic or heteroaryl radical, respectively; and X is a charge-balancing counterion. X may be halogen anion or any monovalent or divalent anion.

In some embodiments, the first structural unit derives from at least one monomer selected from 2-(methacryloyloxy)-ethyltrimethyl ammonium chloride, 2-(acryloyloxyethyl)trimethylammonium chloride, 3-(acrylamidopropyl)trimethylammonium chloride, (vinylbenzyl)trimethylammonium chloride, 2-(acryloyloxyethyl)-N-benzyl-N,N-dimethylammonium chloride, 2-(methacryloyloxy)ethyltrimethylammonium methyl sulfate, 3-(methacrylamidopropyl)trimethylammonium chloride, and diallyldimethylammonium chloride.

In some embodiments, the second structural unit derives from a monomer selected from 2-acrylamido-2-methylpropane sulfonic acid, 3-(allyloxy)-2-hydroxypropane-1-sulfonic acid (sulfonate) and 2-allyoxy-polyethlyene oxide-sulfate.

Except the first and the second structural units, the polymer comprises structural units derived from at least one monomer selected from diethyl 2-(methacryloyloxy) ethyl phosphate, bis[2-(methacryloyloxy)ethyl]phosphate, acrylamide, 2-hydroxyethyl methacrylate, N-(2-hydroxyethyl)acrylamide, poly(ethylene glycol) methyl ether methacrylate, poly(ethylene glycol) methyl ether acrylate, poly(ethylene glycol) ethyl ether methacrylate, poly(ethylene glycol) methacrylate, and 1-vinyl-2-pyrrolidinone.

In some embodiments, the first structural unit is present in an amount corresponding to from about 50 mol % to about 70 mol %, or about 55 mol % to about 60 mol % of all monomer-derived structural units present in the polymer.

In some specific embodiment, the polymer is poly(2-(methacryloyloxy)-ethyltrimethyl ammonium chloride-co-2-acrylamido-2-methylpropane sulfonic acid) of formula

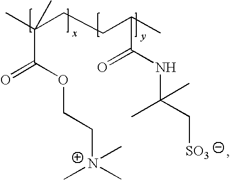

wherein x, y may be any number as long as 2-(methacryloyloxy)-ethyltrimethyl ammonium chloride is from about 30 mol % to about 80 mol % of the polymer.

The aqueous system may be any aqueous system susceptible to scale of silica, such as power plants, evaporative cooling systems, membrane desalination, semiconductor manufacturing, geothermal systems, boiler water, industrial process water, and water in central heating and air conditioning systems.

The polymer and mixture described herein comprise not only structural units inhibiting silica polymerization, but also structural units enhancing dispersion of silica, so effective control of silica scale may be achieved. In addition, the effective dosage of the polymer and mixture may be very low, so it is cost effective. Moreover, the polymer and mixture work in a relatively broad pH scope, e.g., 6.5-7.8, so they reduce difficulties of controlling environment of the water systems. Furthermore, the polymer and mixture are stable in coexistence with halogen, e.g., chlorine gas or sodium hypochlorite (NaOCl), thereby ensuring the silica scale inhibition performance thereof.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 80, preferably from 3 to 80, more preferably from 20 to 70, it is intended that values such as 15 to 75, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Approximating language, as used herein throughout the specification and claims, may be applied to modify any quantitative representation that could permissibly vary without resulting in a change in the basic function to which it is related. Accordingly, a value modified by a term or terms, such as “about”, are not to be limited to the precise value specified. In some instances, the approximating language may correspond to the precision of an instrument for measuring the value.

Silica, as used herein throughout the specification and claims, may be applied to include silicon dioxide, silicates and any other compositions comprising silicon and having possibilities of fouling/scaling in aqueous systems.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphen-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis (cyclohex-4-yl) (i.e., —C₆H₁₀C(CF₃)₂C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —OC₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilylpropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

As used herein the term “alkyl” refers to a saturated hydrocarbon radical. Examples of alkyl groups include n-butyl, n-pentyl, n-heptyl, iso-butyl, t-butyl, and iso-pentyl. The term includes heteroalkyls.

The following examples are included to provide additional guidance to those of ordinary skill in the art in practicing the claimed invention. Accordingly, these examples do not limit the invention as defined in the appended claims.

### EXAMPLES

Examples 1-16 describe the syntheses of polymers and intermediates thereof.

(2-(methacryloyloxy)-ethyltrimethyl ammonium chloride solution, 75 wt. % in H₂O), 2-acryloylamido-2-methylpropane sulfonic acid, poly(ethylene glycol) methyl ether methacrylate, and sodium persulfate (Na₂S₂O₈) were from Aldrich Chemical Co., Milwaukee, Wis., USA unless otherwise specified and were used without further purification. Acrylic acid, sodium hypophosphite (NaH₂PO₂.H₂O) and isopropanol were from Sinopharm Chemical Reagent Co., Ltd, Shanghai, China.

NMR spectra were recorded on a Bruker Avance 400 (¹H & ¹³C, 400 MHz) spectrometer and referenced versus residual solvent shifts. GPC analyses were performed at 40° C. using an apparatus equipped with a Waters 590 pump and a Waters 717-plus injector. A differential refractometry (Waters R410) was used for detection. The column set was composed of Shodex SB-805 HQ/SB-804 HQ with SB-G guard column. The eluent was aqueous solution of 0.1 M NaNO₃ and 0.1% NaN₃ with flow rate 0.5 mL/min. Calibration was performed using poly(styrenesulfonic acid sodium salt) standards (molecular weight from 4.3 to 77 kg). Acquisition, calibration and data treatment software was “Multidetector GPC software”.

### Example 1

### Synthesis of poly(2-(methacryloyloxy)-ethyltrimethyl ammonium chloride-co-2-acrylamido-2-methylpropane sulfonic acid) (molar ratio: 6/4) (sample code: LYG-332-14)

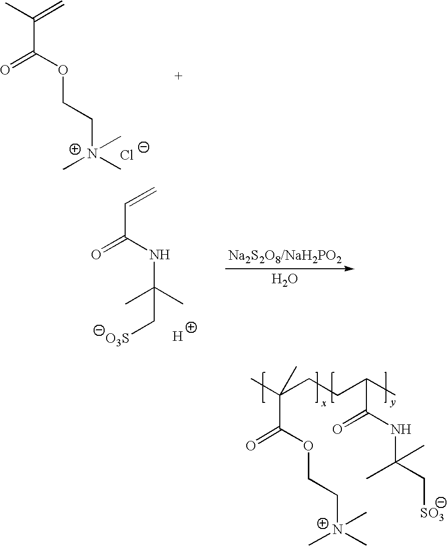

To a 100 mL of three-necked round bottom flask equipped with a thermometer, a nitrogen inlet and addition inlets was charged 6.27 g of deionized water. While sparging with nitrogen, the water was heated to 75° C. for 30 minutes. Then a solution of sodium hypophosphite (0.24 g, 2.3 mmol, 2.5%) was fed to the flask by peristalic pump over 60 minutes. A solution of sodium persulfate (0.44 g, 1.8 mmol, 2%) was fed over 130 minutes. 2-(methacryloyloxy)-ethyltrimethyl ammonium chloride (15.24 g, 55 mmol) and 2-acrylamido-2-methylpropane sulfonic acid (7.6 g, 36.7 mmol) were simultaneously fed over 120 minutes. Upon completion of all the additions, the reaction mixture was heated to 80° C. for 60 minutes. The reaction mixture was cooled below 40° C., and poured into 250 ml of ethanol to afford a solid precipitate which was collected on a filter and washed three times with ethanol (3×20 ml) and dried in a vacuum oven at 50° C. to afford the product copolymer 12.03 g (63%). ¹H NMR (δ, D₂O) 3.7 (br, 0.48H), 3.17 (br, 2.28H), 1.39 (br, 1H). The structure of the product copolymer was verified by ¹³C NMR spectrum to be consistent with the structure shown. The ratio of structural units derived from 2-(methacryloyloxy)-ethyltrimethyl ammonium chloride to structural units derived from 2-acrylamido-2-methylpropane sulfonic acid was found to be 5.95/4.05. Mw: 3688, PD: 1.49.

### Example 2

### Synthesis of poly(2-(methacryloyloxy)-ethyltrimethyl ammonium chloride-co-2-acrylamido-2-methylpropane sulfonic acid) (molar ratio: 7/3) (sample code: HJ-349-25)

To a 100 mL of three neck round bottom flask equipped with a thermometer, a nitrogen inlet and addition inlets was charged 10 g of deionized water. While sparging with nitrogen, the solution was heated to 75° C. for 30 minutes. Then the solution of 2-(methacryloyloxy)-ethyltrimethyl ammonium chloride (17.834 g, 64.4 mmol) and 2-acrylamido-2-methylpropane sulfonic acid (5.72 g, 27.6 mmol) was fed to the flask by peristalic pump over 60 minutes. The solution of sodium persulfate (0.44 g, 1.8 mmol, 2%) was simultaneously fed over 60 minutes. Upon completion of all the additions, the reactor contents were heated to 80° C. for 60 minutes. The reaction was then cooled to lower than 40° C., then poured into 250 ml ethanol. The solid was precipitated from the ethanol solution and was washed with ethanol (20 ml*3). Dried the solid using vacuum oven at 50° C. to get copolymer 18.9 g (98%). The structure of the resulting copolymer was verified by ¹³C NMR as evidenced by the peaks between the region of 50-70 ppm, ¹³C NMR (δ, D₂O) 59.2 (br, 1.41H), 64.3 (br, 1H). 2-(methacryloyloxy)-ethyltrimethyl ammonium chloride: 1/1.41=0.709, the ratio of 2-(methacryloyloxy)-ethyltrimethyl ammonium chloride to 2-acrylamido-2-methylpropane sulfonic acid is 7.09/2.91. Mw: 7146, PD: 1.22.

### Example 3

### Synthesis of poly(2-(methacryloyloxy)-ethyltrimethyl ammonium chloride-co-2-acrylamido-2-methylpropane sulfonic acid) (molar ratio: 6/4) (sample code: HJ-349-23)

To a 100 mL of three neck round bottom flask equipped with a thermometer, a nitrogen inlet and addition inlets was charged 10 g of deionized water. While sparging with nitrogen, the solution was heated to 75° C. for 30 minutes. Then the solution of 2-(methacryloyloxy)-ethyltrimethyl ammonium chloride (15.24 g, 55 mmol) and 2-acrylamido-2-methylpropane sulfonic acid (7.6 g, 36.7 mmol) was fed to the flask by peristalic pump over 60 minutes. The solution of sodium persulfate (0.44 g, 1.8 mmol, 2%) was simultaneously fed over 60 minutes. Upon completion of all the additions, the reactor contents were heated to 80° C. for 60 minutes. The reaction was then cooled to lower than 40° C., then poured into 250 ml ethanol. The solid was precipitated from the ethanol solution and was washed with ethanol (20 ml*3). Dried the solid using vacuum oven at 50° C. to get copolymer 18.3 g (96%). The structure of the resulting copolymer was verified by ¹³C NMR as evidenced by the peaks between the region of 50-70 ppm, ¹³C NMR (δ, D₂O) 59.1 (br, 1.65H), 64.45 (br, 1H). 2-(methacryloyloxy)-ethyltrimethyl ammonium chloride: 1/1.65=0.606, the ratio of 2-(methacryloyloxy)-ethyltrimethyl ammonium chloride to 2-acrylamido-2-methylpropane sulfonic acid is 6.06/3.94. Mw: 13398, PD: 1.54.

### Example 4

### Synthesis of poly(2-(methacryloyloxy)-ethyltrimethyl ammonium chloride-co-2-acrylamido-2-methylpropane sulfonic acid) (molar ratio: 5.5/4.5) (sample code: HJ-349-17)

To a 100 mL of three neck round bottom flask equipped with a thermometer, a nitrogen inlet and addition inlets was charged 10 g of deionized water. While sparging with nitrogen, the solution was heated to 75° C. for 30 minutes. Then the solution of 2-(methacryloyloxy)-ethyltrimethyl ammonium chloride (14 g, 51 mmol) and 2-acrylamido-2-methylpropane sulfonic acid (8.58 g, 41.4 mmol) was fed to the flask by peristalic pump over 60 minutes. The solution of sodium persulfate (0.44 g, 1.8 mmol, 2%) was simultaneously fed over 60 minutes. Upon completion of all the additions, the reactor contents were heated to 80° C. for 60 minutes. The reaction was then cooled to lower than 40° C., then poured into 250 ml ethanol. The solid was precipitated from the ethanol solution and was washed with ethanol (20 ml*3). Dried the solid using vacuum oven at 50° C. to get copolymer 17.89 g (94%). The structure of the resulting copolymer was verified by ¹³C NMR as evidenced by the peaks between the region of 50-70 ppm, ¹³C NMR (δ, D₂O) 59.1 (br, 1.78H), 64.48 (br, 1H). 2-(methacryloyloxy)-ethyltrimethyl ammonium chloride: 1/1.78=0.56, the ratio of 2-(methacryloyloxy)-ethyltrimethyl ammonium chloride to 2-acrylamido-2-methylpropane sulfonic acid is 5.6/4.4. Mw: 30071, PD: 1.88.

### Example 5

### Synthesis of poly(2-(methacryloyloxy)-ethyltrimethyl ammonium chloride-co-2-acrylamido-2-methylpropane sulfonic acid) (molar ratio: 5.0/5.0) (sample code: HJ-349-16)

To a 100 mL of three neck round bottom flask equipped with a thermometer, a nitrogen inlet and addition inlets was charged 10 g of deionized water. While sparging with nitrogen, the solution was heated 75° C. for 30 minutes. Then the solution of 2-(methacryloyloxy)-ethyltrimethyl ammonium chloride (12.74 g, 46 mmol) and 2-acrylamido-2-methylpropane sulfonic acid (9.534 g, 46 mmol) was fed to the flask by peristalic pump over 60 minutes. The solution of sodium persulfate (0.44 g, 1.8 mmol, 2%) was simultaneously fed over 60 minutes. Upon completion of all the additions, the reactor contents were heated to 80° C. for 60 minutes. The reaction was then cooled to lower than 40° C., then poured into 250 ml ethanol. The solid precipitated from the ethanol solution and washed with ethanol (20 ml*3). Dried the solid using vacuum oven at 50° C. to get copolymer 17.98 g (95%). The structure of the resulting copolymer was verified by ¹³C NMR as evidenced by the peaks between the region of 50-70 ppm, ¹³C NMR (δ, D₂O) 58.95 (br, 1.96H), 64.51 (br, 1H). 2-(methacryloyloxy)-ethyltrimethyl ammonium chloride: 1/1.96=0.51, the molar ratio of 2-(methacryloyloxy)-ethyltrimethyl ammonium chloride to 2-acrylamido-2-methylpropane sulfonic acid is 5.1/4.9. Mw: 45851, PD: 2.38.

### Example 6

### Synthesis of poly(2-(methacryloyloxy)-ethyltrimethyl ammonium chloride-co-2-acrylamido-2-methylpropane sulfonic acid) (molar ratio: 4.0/6.0) (sample code: HJ-349-19)

To a 100 mL of three neck round bottom flask equipped with a thermometer, a nitrogen inlet and addition inlets was charged 10 g of deionized water. While sparging with nitrogen, the solution was heated to 75° C. for 30 minutes. Then the solution of 2-(methacryloyloxy)-ethyltrimethyl ammonium chloride (10.2 g, 36.8 mmol) and 2-acrylamido-2-methylpropane sulfonic acid (11.44 g, 55.2 mmol) was fed to the flask by peristalic pump over 60 minutes. The solution of sodium persulfate (0.44 g, 1.8 mmol, 2%) was simultaneously fed over 60 minutes. Upon completion of all the additions, the reactor contents were heated to 80° C. for 60 minutes. The reaction was then cooled to lower than 40° C., then poured into 250 ml ethanol. The solid precipitated from the ethanol solution was washed with ethanol (20 ml*3). Dried the solid using vacuum oven at 50° C. to get copolymer 18.25 g (96%). The structure of the resulting copolymer was verified by ¹³C NMR as evidenced by the peaks between the region of 50-70 ppm, ¹³C NMR (δ, D₂O) 58.8 (br, 2.43H), 64.53 (br, 1H). 2-(methacryloyloxy)-ethyltrimethyl ammonium chloride: 1/2.43=0.41, the molar ratio of 2-(methacryloyloxy)-ethyltrimethyl ammonium chloride to 2-acrylamido-2-methylpropane sulfonic acid is 4.1/5.9. Mw: 75259, PD: 2.51.

### Example 7

### Synthesis of poly(2-(methacryloyloxy)-ethyltrimethyl ammonium chloride-co-2-acrylamido-2-methylpropane sulfonic acid) (molar ratio: 3.5/6.5) (sample code: HJ-349-21)

To a 100 mL of three neck round bottom flask equipped with a thermometer, a nitrogen inlet and addition inlets was charged 10 g of deionized water. While sparging with nitrogen, the solution was heated 75° C. for 30 minutes. Then the solution of 2-(methacryloyloxy)-ethyltrimethyl ammonium chloride (8.917 g, 32.2 mmol) and 2-acrylamido-2-methylpropane sulfonic acid (12.393 g, 59.8 mmol) was fed to the flask by peristalic pump over 60 minutes. The solution of sodium persulfate (0.44 g, 1.8 mmol, 2%) was simultaneously fed over 60 minutes. Upon completion of all the additions, the reactor contents were heated to 80° C. for 60 minutes. The reaction was then cooled to lower than 40° C., then poured into 250 ml ethanol. The solid precipitated from the ethanol solution was washed with ethanol (20 ml*3). Dried the solid using vacuum oven at 50° C. to get copolymer 18.9 g (99%). The structure of the resulting copolymer was verified by ¹³C NMR as evidenced by the peaks between the region of 50-70 ppm, ¹³C NMR (δ, D₂O) 58.47 (br, 2.85H), 64.49 (br, 1H). 2-(methacryloyloxy)-ethyltrimethyl ammonium chloride: 1/2.85=0.351, the molar ratio of 2-(methacryloyloxy)-ethyltrimethyl ammonium chloride to 2-acrylamido-2-methylpropane sulfonic acid is 3.51/6.49. Mw: 155936, PD: 3.93.

### Example 8

### Synthesis of poly(2-(methacryloyloxy)-ethyltrimethyl ammonium chloride-co-2-acrylamido-2-methylpropane sulfonic acid) (molar ratio: 3/7) (sample code: HJ-349-22)

To a 100 mL of three neck round bottom flask equipped with a thermometer, a nitrogen inlet and addition inlets was charged 10 g of deionized water. While sparging with nitrogen, the solution was heated to 75° C. for 30 minutes. Then the solution of 2-(methacryloyloxy)-ethyltrimethyl ammonium chloride (7.643 g, 27.6 mmol) and 2-acrylamido-2-methylpropane sulfonic acid (13.347 g, 64.4 mmol) was fed to the flask by peristalic pump over 60 minutes. The solution of sodium persulfate (0.44 g, 1.8 mmol, 2%) was simultaneously fed over 60 minutes. Upon completion of all the additions, the reactor contents were heated to 80° C. for 60 minutes. The reaction was then cooled to lower than 40° C., then poured into 250 ml ethanol. The solid precipitated from the ethanol solution was washed with ethanol (20 ml*3). Dried the solid using vacuum oven at 50° C. to get copolymer 12 g (66%). The structure of the resulting copolymer was verified by ¹³C NMR as evidenced by the peaks between the region of 50-70 ppm, ¹³C NMR (δ, D₂O) 58.16 (br, 3.19H), 64.42 (br, 1H). 2-(methacryloyloxy)-ethyltrimethyl ammonium chloride: 1/3.19=0.31, the molar ratio of 2-(methacryloyloxy)-ethyltrimethyl ammonium chloride to 2-acrylamido-2-methylpropane sulfonic acid is 3.1/6.9. Mw: 84076, PD: 2.65.

### Example 9

### Synthesis of poly(2-(methacryloyloxy)-ethyltrimethyl ammonium chloride-co-acrylic acid) (molar ratio: 7/3) (sample code: SC-MA73)

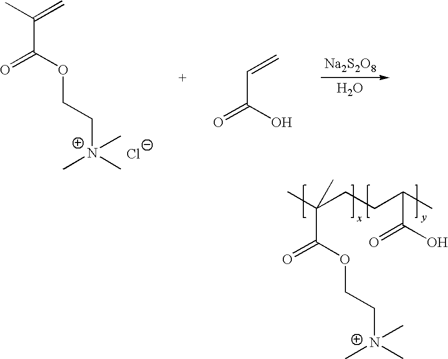

To a 100 mL of three neck round bottom flask equipped with a thermometer, a nitrogen inlet and addition inlets was charged 50 g of deionized water, 2-(methacryloyloxy)-ethyltrimethyl ammonium chloride (7 g, 33.7 mmol), acrylic acid (1.04 g, 14.44 mmol) and sodium persulfate (0.32 g, 1.34 mmol, 3%). While sparging with nitrogen, the solution was stirred for 30 minutes at room temperature. Then the reactor contents were heated to 80° C. for 16 hours. The reaction was then cooled to lower than 40° C., then poured into 250 ml isopropanol. The solid was precipitated from the isopropanol solution and was washed with isopropanol (20 ml*3). Dried the solid using vacuum oven at 50° C. to get copolymer 6.2 g (78%). Mw: 12392, PD: 1.3.

### Example 10

### Synthesis of sample codes SC-MA64, SC-MA55, SC-MA46 and SC-MA37

Under the similar reaction conditions as EXAMPLE 9, other poly(2-(methacryloyloxy)-ethyltrimethyl ammonium chloride-co-acrylic acid) with different molar ratios were also synthesized. Detail data about synthesis of all poly(2-(methacryloyloxy)-ethyltrimethyl ammonium chloride-co-acrylic acid) are shown in the following table.

| | 2-(methacryloyloxy)- | | | |
|---|---|---|---|---|
| | ethyltrimethyl | | | |
| | ammonium chloride/acrylic | | | |
| Sample code | acid molar ratio | Mw | PD | Yied (%) |
| SC-MA73 | 7/3 | 12,392 | 1.3 | 78 |
| SC-MA64 | 6/4 | 50,425 | 1.39 | 65 |
| SC-MA55 | 5/5 | 44,283 | 2.3 | 89 |
| SC-MA46 | 4/6 | 126,403 | 3.02 | 24 |
| SC-MA37 | 3/7 | 127,683 | 3.03 | 21 |

### Example 11

### Synthesis of poly(2-acrylamido-2-methylpropane sulfonic acid-co-acrylic amide) (molar ratio: 3/7) (sample code: HJ-349-76)

To a 100 mL of three neck round bottom flask equipped with a thermometer, a nitrogen inlet and addition inlets was charged 10 g of deionized water and 1.5 ml isopropanol. While sparging with nitrogen, the solution was heated 50° C. for 30 minutes. Then the solution of 2-acrylamido-2-methylpropane sulfonic acid (6.0 g, 28.95 mmol), NaOH (1.158 g, 28.95 mmol) and acrylic amide (9.6 g, 67.55 mmol, from Sinopharm Chemical Reagent Co., Ltd, Shanghai, China) were fed to the flask by peristalic pump over 60 minutes. The solution of sodium persulfate (0.45 g, 1.89 mmol, 2%) and 6 ml isopropanol was simultaneously fed over 60 minutes. Upon completion of all the additions, the reactor contents were heated to 60° C. for 60 minutes. The solid loading is 19.38%. The structure of the resulting copolymer was verified by ¹³C NMR as evidenced by the peaks between the region of 170-190 ppm, ¹³C NMR (δ, D₂O) 179.61 (s, 2.37H), 175.85 (br, 1H). 2-acrylamido-2-methylpropane sulfonic acid: 1/3.41=2.97, the ratio of 2-acrylamido-2-methylpropane sulfonic acid to acrylic amide is 2.97/7.03.

### Example 12

### Synthesis of poly(2-acrylamido-2-methylpropane sulfonic acid-co-acrylic amide) (molar ratio: 5/5) (sample code: HJ-349-77)

To a 100 mL of three neck round bottom flask equipped with a thermometer, a nitrogen inlet and addition inlets was charged 10 g of deionized water and 1.5 ml isopropanol. While sparging with nitrogen, the solution was heated 50° C. for 30 minutes. Then the solution of 2-acrylamido-2-methylpropane sulfonic acid (5.0 g, 24 mmol), NaOH (0.965 g, 24 mmol) and acrylic amide (3.425 g, 24 mmol, from Sinopharm Chemical Reagent Co., Ltd, Shanghai, China) was fed to the flask by peristalic pump over 60 minutes. The solution of sodium persulfate (0.45 g, 1.89 mmol, 2%) and 4.5 ml isopropanol was simultaneously fed over 60 minutes. Upon completion of all the additions, the reactor contents were heated to 60° C. for 60 minutes. The solid loading is 15.5%. The structure of the resulting copolymer was verified by ¹³C NMR as evidenced by the peaks between the region of 170-190 ppm, ¹³C NMR (δ, D₂O) 179.67 (s, 1.04H), 175.95 (br, 1H). 2-acrylamido-2-methylpropane sulfonic acid: 1/2.04=0.49, the ratio of 2-acrylamido-2-methylpropane sulfonic acid to acrylic amide is 4.9/5.1.

### Example 13

### Synthesis of poly(2-(methacryloyloxy)-ethyltrimethyl ammonium chloride-co-acrylic amide) (molar ratio: 5/5) (sample code: HJ-349-84)

To a 100 mL of three neck round bottom flask equipped with a thermometer, a nitrogen inlet and addition inlets was charged 10 g of deionized water and 1.0 ml isopropanol. While sparging with nitrogen, the solution was heated 50° C. for 30 minutes. Then the solution of 2-(methacryloyloxy)-ethyltrimethyl ammonium chloride (5 g, 19.3 mmol) and acrylic amide (2.74 g, 19.3 mmol, from Sinopharm Chemical Reagent Co., Ltd, Shanghai, China) was fed to the flask by peristalic pump over 60 minutes. The solution of sodium persulfate (0.183 g, 0.76 mmol, 2%) and 2 ml isopropanol was simultaneously fed over 60 minutes. Upon completion of all the additions, the reactor contents were heated to 60° C. for 60 minutes. The solid loading is 15.0%. The structure of the resulting copolymer was verified by ¹³C NMR as evidenced by the peaks between the region of 170-190 ppm, ¹³C NMR (δ, D₂O) 179.67 (bs, 1.02H), 177.15 (br, 1H). 2-(methacryloyloxy)-ethyltrimethyl ammonium chloride: 1/2.02=0.495, the ratio of 2-(methacryloyloxy)-ethyltrimethyl ammonium chloride to acrylic amide is 4.95/5.05. The molecular weight of the resulting polymer was 439,622.

### Example 14

### Synthesis of poly(2-(methacryloyloxy)-ethyltrimethyl ammonium chloride-co-(ethylene glycol) methyl ether methacrylate) (sample code: HJ-349-88)

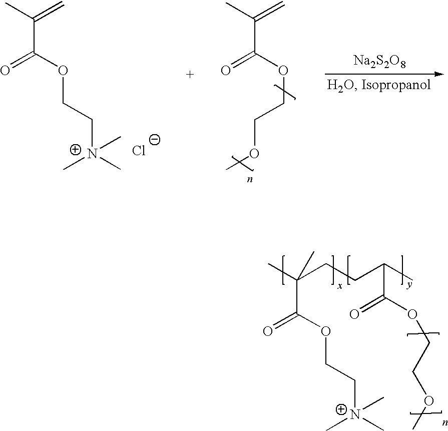

To a 100 mL of three neck round bottom flask equipped with a thermometer, a nitrogen inlet and addition inlets were charged 5 g of deionized water and 0.5 ml isopropanol. While sparging with nitrogen, the solution was heated 50° C. for 30 minutes. 2-(methacryloyloxy)-ethyltrimethyl ammonium chloride (2.5 g, 9.63 mmol) and poly(ethylene glycol) methyl ether methacrylate (Mn: 300, 2.06 g, 6.83 mmol) were dissolved in deionized water (20 ml) and isopropanol (2 mL). Then the solution was fed to the flask by peristalic pump over 60 minutes. The solution of sodium persulfate (65 mg, 0.27 mmol, 1.63%) was simultaneously fed over 760 minutes. Upon completion of all the additions, the reactor contents were heated to 60° C. for 60 minutes. The reaction was then cooled to room temperature. The solid loading of product is 12.3%. Mw: 871449, PD: 8.53.

### Example 15

### Synthesis of poly(2-(methacryloyloxy)-ethyltrimethyl ammonium chloride) (sample code: HJ-349-14)

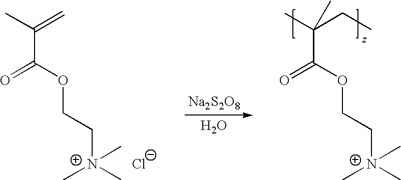

To a 50 mL of three neck round bottom flask equipped with a thermometer, a nitrogen inlet and addition inlets was charged 10 g of deionized water. While sparging with nitrogen, the solution was heated 75° C. for 30 minutes. Then the solution of 2-(methacryloyloxy)-ethyltrimethyl ammonium chloride (15.24 g, 55 mmol) was fed to the flask by peristalic pump over 60 minutes. The solution of sodium persulfate (0.27 g, 1.1 mmol, 2%) was simultaneously fed over 60 minutes. Upon completion of all the additions, the reactor contents were heated to 80° C. for 60 minutes. The reaction was then cooled to lower than 40° C., then poured into 250 ml ethanol. The solid precipitated from the ethanol solution was washed with ethanol (20 ml*3). Dried the solid using vacuum oven at 50° C. to get polymer 9.64 g (84.3%). Mw: 2395, PD: 1.02.

### Example 16

### Synthesis of poly(2-acrylamido-2-methylpropane sulfonic acid) (sample code: HJ-349-46)

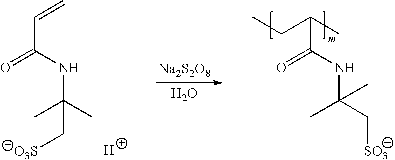

To a 50 mL of three neck round bottom flask equipped with a thermometer, a nitrogen inlet and addition inlets was charged 10 g of deionized water. While sparging with nitrogen, the solution was heated 75° C. for 30 minutes. Then the solution of 2-acrylamido-2-methylpropane sulfonic acid (13.84 g, 66.4 mmol) was fed to the flask by peristalic pump over 60 minutes. The solution of sodium persulfate (0.33 g, 1.3 mmol, 2%) was simultaneously fed over 60 minutes. Upon completion of all the additions, the reactor contents were heated to 80° C. for 60 minutes. The reaction was then cooled to lower than 40° C., then poured into 250 ml ethanol. The solid precipitated from the ethanol solution was washed with ethanol (20 ml*3). Dried the solid using vacuum oven at 50° C. to get polymer 13.56 g (98%). Mw: 3931, PD: 1.05.

### Silica Inhibition Tests:

Bottle tests in general are intended to be an initial screening method for the identification of new silica control inhibitors. Results of these tests are expressed as “percent inhibition” which can be described as the capacity of a material, usually a polymer, to prevent silica polymerization. This is a “dynamic” test, meaning that the bottles are heated and shaken, during the equilibration period. In detail, the test includes the following steps.

Firstly, prepare cation solution (makeup A: 1.587 g/L CaCl₂*2H₂O, 1.773 g/L MgSO₄*7H₂O and 2.65 mL/L 10 N H₂SO₄) and anion solution (makeup B: 0.336 g/L NaHCO₃ and 2.760 g/L Na₂SiO₃.5H₂O). Adjust the makeup parameters to be as follows: 540 ppm Ca as CaCO₃, 360 ppm Mg as MgCO₃, 350 ppm SiO₂, initial pH ˜7.0, and ending pH<8.1, all of which are calculated for a 50:50 (volume) mix of makeup A and makeup B.

Next, dispense 50 mL of makeup A into a clean 4 oz. bottle; carefully add a given amount of the treatment (polymer or mixture of polymers) followed by swirling to mix; add 50 mL of makeup B; cap tightly and shake; repeat the aforementioned steps until each formulation has a duplicate; make duplicate control bottles (makeup B+makeup A) containing no treatment; make duplicate stock bottles (50 mL makeup B+50 mL DI); and place the bottles into a water bath controlled at 40° C.-42° C.

Finally, after 7 days, analyze samples for reactive silica using the HACH Silica (Silicomolybdate) Method, which is based on the principle that ammonium molybdate reacts with reactive silica (RS) at low pH (˜1.2) and yields heteropoly acids in yellow color: firstly, dilute samples by adding 1 mL sample to 9 mL of silica free DI water (10 mL total); then, add one bag of molybdate reagent (Cat. No. 21073-69, from HACH, Loveland, USA) comprising sodium molybdate and one bag of acid reagent (Cat. No. 21074-69, from HACH, Loveland, USA) comprising sulfuric acid and sodium chloride, respectively; leave the solution undisturbed for 10 minutes after mixing well; and set spectrophotometer at zero absorbance with DI water as the blank and measure samples at 452 nm as ppm reactive silica. Once samples have been taken for silica analysis, the solution appearances/deposit and pH are also measured and recorded.

The percent inhibition is calculated by this formula:

$$\% Inhibition = \frac{ppm SiO 2 ( treated sample ) - ppm SiO 2 ( control average )}{ppm SiO 2 ( stock average ) - ppm SiO 2 ( control average )} \times 100$$

The silicomolybdate test measures “soluble” or “reactive silica”. It does not measure “colloidal silica”. The term “reactive silica” represents not only monomeric silicic acid but also other “oligomeric species” such as dimmer, trimers, tetramer, etc. For practical purposes, the silicomolybdate test results are associated with all forms of reactive silica except colloidal form. The screening and testing procedures were reproduced at least two times, and the relative error was within ±5%.

### Example 17

Table 1 illustrates results from the 7 days bottle tests about the silica inhibition efficacy of 2-(methacryloyloxy)-ethyltrimethyl ammonium chloride/2-acrylamido-2-methylpropane sulfonic acid copolymer samples having different 2-(methacryloyloxy)-ethyltrimethyl ammonium chloride percentages. Neither the cationic 2-(methacryloyloxy)-ethyltrimethyl ammonium chloride homopolymer (Sample HJ-349-14) nor the anionic 2-acrylamido-2-methylpropane sulfonic acidhomopolymer (Sample HJ-349-46) exhibits efficient silica inhibition at the 30 ppm level as evidenced by the relatively low values (174, 176 and 158, 162) observed for reactive silica after seven days which correspond to % inhibition values of from about 2.5 to about 11%. The silica inhibition efficacy was relatively insensitive to changes in the copolymer composition when concentration of structural units derived from 2-(methacryloyloxy)-ethyltrimethyl ammonium chloride was less than 50 mol % of all of the monomer derived structural units present in the copolymer, but increased dramatically from less than 20% to more than 70% when the concentration of structural units derived from 2-(methacryloyloxy)-ethyltrimethyl ammonium chloride reaches 55 mol % of the copolymer. Higher concentrations of structural units derived from 2-(methacryloyloxy)-ethyltrimethyl ammonium chloride did not provide more robust silica inhibition. Thus, the efficacy decreased to 34% as the 2-(methacryloyloxy)-ethyltrimethyl ammonium chloride further increased to 60 mol % of the copolymer and less than 20% when 2-(methacryloyloxy)-ethyltrimethyl ammonium chloride reached 70 mol % of the copolymer.

TABLE 1
Silica Inhibition by 2-(methacryloyloxy)-ethyltrimethyl ammonium
chloride/2-acrylamido-2-methylpropane sulfonic acid copolymers

| | | | RS | | | pH |
|---|---|---|---|---|---|---|
| | molar | Treatment | (day 7) | RS | Inhibition | (day |
| Samples | ratio | dosage | ppm | average | (%) | 7) |
| Control | | 0 ppm | 156 | | | 8.04 |
| Control | | 0 ppm | 154 | 155 | 0 | 8.02 |
| HJ-349-25 | 7.0/3.0 | 30 ppm | 165 | | | |
| HJ-349-25 | 7.0/3.0 | 30 ppm | 165 | 165 | 5.14 | |
| LYG-332-14 | 6.0/4.0 | 30 ppm | 208 | | | |
| LYG-332-14 | 6.0/4.0 | 30 ppm | 234 | 221 | 33.5 | |
| HJ-349-23 | 6.0/4.0 | 30 ppm | 220 | | | |
| HJ-349-23 | 6.0/4.0 | 30 ppm | 211 | 215.5 | 31.11 | |
| HJ-349-17 | 5.5/4.5 | 30 ppm | 301 | | | 7.82 |
| HJ-349-17 | 5.5/4.5 | 30 ppm | 295 | 298 | 73.52 | 7.94 |
| HJ-349-16 | 5/5 | 30 ppm | 200 | | | 7.81 |
| HJ-349-16 | 5/5 | 30 ppm | 185 | 192.5 | 19.28 | 7.88 |
| HJ-349-20 | 4.5/5.5 | 30 ppm | 205 | | | 7.96 |
| HJ-349-20 | 4.5/5.5 | 30 ppm | 183 | 194 | 20.05 | 8.01 |
| HJ-349-19 | 4/6 | 30 ppm | 143 | | | 8.01 |
| HJ-349-19 | 4/6 | 30 ppm | 148 | 145.5 | −4.88 | 8.05 |
| HJ-349-21 | 3.5/6.5 | 30 ppm | 163 | | | 8.01 |
| HJ-349-21 | 3.5/6.5 | 30 ppm | 162 | 162.5 | 3.86 | 8.03 |
| HJ-349-22 | 3.0/7.0 | 30 ppm | 170 | | | |
| HJ-349-22 | 3.0/7.0 | 30 ppm | 165 | 167.5 | 6.43 | |
| HJ-349-14 | 1/0 | 30 ppm | 174 | | | 7.95 |
| HJ-349-14 | 1/0 | 30 ppm | 178 | 176 | 10.80 | 7.93 |
| HJ-349-46 | 0/1 | 30 ppm | 158 | | | |
| HJ-349-46 | 0/1 | 30 ppm | 162 | 160 | 2.57 | |
| Stock | | | 350 | | | |
| Stock | | | 349 | 349.5 | | |

In Table 1, “RS” is a contracted form of the term “reactive silica”. Samples HJ-349-20 are synthesized by method similar with those in Examples 2-8 except the amount of materials used.

### Comparative Example 1

Table 2 illustrates the silica control performance of 2-(methacryloyloxy)-ethyltrimethyl ammonium chloride/acrylic acid copolymers in which the concentration of structural units derived from 2-(methacryloyloxy)-ethyltrimethyl ammonium chloride present in the copolymer was systematically varied from about 30 mol % to about 70 mol % of all monomer derived structural units present in the copolymer. For the control (no treatment), reactive silica decreased greatly from initial 360 ppm to 244 ppm after 48 hours, then further decreased to 181 ppm at 72 hours, and slowly decreased to 155 ppm after 168 hours. The 2-(methacryloyloxy)-ethyltrimethyl ammonium chloride/acrylic acid copolymers exhibited varying levels of silica inhibition, which was especially pronounced when structural units derived from 2-(methacryloyloxy)-ethyltrimethyl ammonium chloride were in a range from about 30 to about 60 mol %. See for example, the very high level of inhibition was observed for Samples SC-MA37, SC-MA46, SC-MA55 and SC-MA64 at 48 hours, whose reactive silica is above 330 ppm within 48 hours. However, the performance of 2-(methacryloyloxy)-ethyltrimethyl ammonium chloride/acrylic acid polymers decreased with the time passed.

TABLE 2

| | Average reactive silica (ppm) | | | | | |
|---|---|---|---|---|---|---|
| Time | | | | | | SC- |
| (hrs) | Control | SC-MA37 | SC-MA46 | SC-MA55 | SC-MA64 | MA73 |
| 0 | 360 | 360 | 360 | 360 | 360 | 360 |
| 24 | 346 | 362 | 360 | 357 | 356 | 349 |
| 48 | 244 | 356 | 352 | 334 | 328 | 277 |
| 72 | 181 | 332 | 320 | 318 | 290 | 276 |
| 144 | 160 | 190 | 232 | 229 | 211 | 207 |
| 168 | 155 | 172 | 206 | 199 | 198 | 189 |

Table 3 illustrates net charges of poly(2-(methacryloyloxy)-ethyltrimethyl ammonium chloride/2-acrylamido-2-methylpropane sulfonic acid) with different molar ratios of structural units thereof.

TABLE 3

| | | 2-acrylamido-2- | |
|---|---|---|---|
| | 2-(methacryloyloxy)- | methylpropane | |
| | ethyltrimethyl ammonium | sulfonic acid | Net charge |
| sample code | chloride (mol %) | (mol %) | (df) |
| HJ-349-46 | 0 | 100 | −1 |
| HJ-349-22 | 30 | 70 | −0.4 |
| HJ-349-19 | 40 | 60 | −0.2 |
| HJ-349-16 | 50 | 50 | 0 |
| HJ-349-23 | 60 | 40 | 0.2 |
| HJ-349-25 | 70 | 30 | 0.4 |
| HJ-349-14 | 100 | 0 | 1 |

### Example 18

Mixtures of two polymers respectively having positive or neutral net charges (δf≧0) were used as treatments and table 4 shows the bottle test results of the mixtures after 7 days. Different 2-(methacryloyloxy)-ethyltrimethyl ammonium chloride concentrations in the mixtures were obtained by adjusting copolymer-blending ratios.

TABLE 4
silica control performance for mixtures of two polymers with positive or
neutral net charges (δf ≧ 0)

| | | | | | Mol % of 2- | | |
|---|---|---|---|---|---|---|---|
| | | Dosage | Dosage | | (methacryloyloxy)- | Average | |
| | | of | of | Total | ethyltrimethyl | reactive | |
| | | Polymer | polymer | dosage | ammonium chloride in | silica | Inhibition |
| Polymer 1 | Polymer 2 | 1 (ppm) | 2 (ppm) | (ppm) | blends | (ppm) | (%) |
| HJ-349-16 | HJ-349-14 | 30 | 0 | 30 | 50 | 172 | 9 |
| | | 27 | 3 | 30 | 55 | 302 | 71 |
| | | 24 | 6 | 30 | 60 | 277 | 59 |
| | | 18 | 12 | 30 | 70 | 263 | 53 |
| | | 12 | 18 | 30 | 80 | 198 | 22 |
| | | 0 | 30 | 30 | 100 | 173 | 9 |
| HJ-349-23 | HJ-349-14 | 30 | 0 | 30 | 60 | 211 | 28 |
| | | 22.5 | 7.5 | 30 | 70 | 196 | 20 |
| | | 15 | 15 | 30 | 80 | 173 | 9 |
| HJ-349-16 | HJ-349-23 | 15 | 15 | 30 | 55 | 301 | 71 |

| | | |
|---|---|---|
| Control | 153 | 0 |
| Stock | 361 | 100 |

### Example 19

Mixtures of two polymers respectively having negative net charge (δf<0) and positive net charge (δf>0) were used as treatments. Different 2-(methacryloyloxy)-ethyltrimethyl ammonium chloride concentrations in the mixtures were obtained by adjusting copolymer blending ratios. Total polymer dosage of each mixture was 30 ppm. Table 5 shows the bottle test results after 7 days.

TABLE 5
silica control performance for blends of two polymers with negative net
charge (δf < 0) and positive net charge (δf > 0)

| | | | | | Mol % of 2- | | |
|---|---|---|---|---|---|---|---|
| | | Dosage of | Dosage of | Total | (methacryloyloxy)- | Average | |
| | | Polymer 1 | polymer 2 | dosage | ethyltrimethyl ammonium | reactive | Inhibition |
| Polymer 1 | Polymer 2 | (ppm) | (ppm) | (ppm) | chloride in blends | silica (ppm) | (%) |
| HJ-349- | HJ-349- | 30 | 0 | 30 | 0 | 160 | −1 |
| 46 | 14 | 21 | 9 | 30 | 30 | 168 | 3 |
| | | 18 | 12 | 30 | 40 | 173 | 6 |
| | | 15 | 15 | 30 | 50 | 163 | 1 |
| | | 12 | 18 | 30 | 60 | 282 | 61 |
| | | 9 | 21 | 30 | 70 | 240 | 40 |
| | | 0 | 30 | 30 | 100 | 173 | 6 |
| HJ-349- | HJ-349- | 17.1 | 12.9 | 30 | 30 | 301 | 71 |
| 46 | 25 | 12.9 | 17.1 | 30 | 40 | 283 | 61 |
| | | 8.7 | 21.3 | 30 | 50 | 293 | 66 |
| | | 4.2 | 25.8 | 30 | 60 | 249 | 44 |
| | | 0 | 30 | 30 | 70 | 199 | 19 |
| HJ-349- | HJ-349- | 30 | 0 | 30 | 30 | 170 | 4 |
| 22 | 14 | 25.8 | 4.2 | 30 | 40 | 177 | 7 |
| | | 23.7 | 6.3 | 30 | 45 | 193 | 15 |
| | | 21.3 | 8.7 | 30 | 50 | 259 | 49 |
| | | 19.2 | 10.8 | 30 | 55 | 296 | 68 |
| | | 17.1 | 12.9 | 30 | 60 | 292 | 66 |
| | | 12.9 | 17.1 | 30 | 70 | 276 | 58 |
| HJ-349- | HJ-349- | 22.5 | 7.5 | 30 | 40 | 199 | 19 |
| 22 | 25 | 18.9 | 11.1 | 30 | 45 | 316 | 78 |
| | | 15.0 | 15.0 | 30 | 50 | 316 | 78 |
| | | 11.4 | 18.6 | 30 | 55 | 311 | 75 |
| | | 7.5 | 22.5 | 30 | 60 | 306 | 73 |

| | | |
|---|---|---|
| Control | 162 | 0 |
| Stock | 359 | 100 |

### Example 20

Mixtures of poly(2-(methacryloyloxy)-ethyltrimethyl ammonium chloride/acrylic amide) (sample code: HJ-349-84) with 50 mol % of 2-(methacryloyloxy)-ethyltrimethyl ammonium chloride and poly(2-acrylamido-2-methylpropane sulfonic acid/acrylic amide) (sample code: HJ-349-77) with 50 mol % of 2-acrylamido-2-methylpropane sulfonic acid were used as treatments and the silica control performances after 7 days were shown in Table 6.

TABLE 6

| Dosage | Dosage | | Mol % of | | |
|---|---|---|---|---|---|
| of | of | | 2-(methacryloyloxy)- | | |
| HJ- | HJ- | Total | ethyltrimethyl | Average | |
| 349-84 | 349-77 | dosage | ammonium | reactive | Inhibition |
| (ppm) | (ppm) | (ppm) | chloride in blends | silica | (%) |
| 12 | 18 | 30 | 20 | 286 | 67 |
| 40 | 60 | 100 | 20 | 292 | 72 |
| 18 | 12 | 30 | 30 | 284 | 68 |
| 60 | 40 | 100 | 30 | 288 | 70 |

| | | |
|---|---|---|
| Control | 148 | 0 |
| Stock | 349 | 100 |

### Example 21

Blends of poly(2-(methacryloyloxy)-ethyltrimethyl ammonium chloride/(ethylene glycol) methyl ether methacrylate) (sample code: HJ-349-88) with 58 mol % of 2-(methacryloyloxy)-ethyltrimethyl ammonium chloride and poly(2-acrylamido-2-methylpropane sulfonic acid) (HJ-349-46) were used as treatments and the silica control performances after 7 days were shown in Table 7.

TABLE 7

| Dosage | Dosage | | Mol % of | | |
|---|---|---|---|---|---|
| of | of | | 2-(methacryloyloxy)- | Average | |
| HJ- | HJ- | Total | ethyltrimethyl | reactive | |
| 349-88 | 349-46 | polymer | ammonium | silica | Inhibition |
| (ppm) | (ppm) | dosage | chloride in blends | (ppm) | (%) |
| 11.4 | 18.6 | 30 | 18 | 198 | 17 |
| 14.6 | 15.4 | 30 | 24 | 277 | 57 |
| 17.6 | 12.4 | 30 | 29 | 292 | 65 |
| 20.5 | 9.5 | 30 | 35 | 285 | 62 |
| 23.1 | 6.9 | 30 | 41 | 217 | 27 |
| 30.0 | 0.0 | 30 | 58 | 189 | 13 |

| | | |
|---|---|---|
| Control | 163 | 0 |
| Stock | 361 | 100 |

### Example 22

Mixtures of poly(2-(methacryloyloxy)-ethyltrimethyl ammonium chloride) (sample code: HJ-349-14) or poly(2-(methacryloyloxy)-ethyltrimethyl ammonium chloride-co-2-acrylamido-2-methylpropane sulfonic acid) (sample code: HJ-349-25) and various anionic polymers were used as treatments. Some of the anionic polymers used in the tests are given in Table 8 and the silica control performances after 7 days are shown in Tables 9-11.

TABLE 8

| Code | Chemical name | Commercial source |
|---|---|---|
| PAA | Poly(acrylic acid) | Sinopharm |
| | | Chemical |
| | | Reagent Co. Ltd |
| Acumer ™ | Poly(acrylic acid) | Rohm and Haas |
| 1000 | | Company |
| Acumer ™ | Poly(acrylic acid) | Rohm and Haas |
| 1100 | | Company |
| Acumer ™ | Poly(acrylic acid-co-2-acrylamido-2- | Rohm and Haas |
| 2000 | methylpropane sulfonic acid) | Company |
| SAA 1 | poly(acrylic acid-co-1-allyloxy-2- | General Electric |
| | hydroxy propyl sulfonate) | Company |
| SAA 2 | poly(acrylic acid-co-1-allyloxy- | General Electric |
| | polyethylene oxide-sulfate-co-1- | Company |
| | allyoxy-2-hydroxy propyl sulfonate) | |
| SAA 3 | poly(acrylic acid-co-1-allyloxy- | General Electric |
| | polyethylene oxide-sulfate) | Company |
| SAA 4 | Poly (acrylic acid-co-2-acrylamido-2- | Shandong Taihe |
| | methylpropane sulfonic acid) | Water- |
| | | Treatment Co., Ltd. |

TABLE 9

| | | dosage | dosage | | average | |
|---|---|---|---|---|---|---|
| | | of cationic | of anionic | total | reactive | |
| cationic | anionic | polymer | polymer | dosage | silica | Inhibition |
| polymer | polymer | (ppm) | (ppm) | (ppm) | (ppm) | (%) |
| HJ-349- | SAA 1 | 2.88 | 4.12 | 7 | 155 | 0 |
| 14 | | 4.12 | 5.88 | 10 | 156 | 1 |
| | | 6.17 | 8.83 | 15 | 164 | 5 |
| | | 8.23 | 11.77 | 20 | 179 | 13 |
| | | 10.29 | 14.71 | 25 | 222 | 36 |
| | | 12.35 | 17.65 | 30 | 294 | 73 |
| | SAA 2 | 2.42 | 4.58 | 7 | 166 | 6 |
| | | 3.45 | 6.55 | 10 | 165 | 6 |
| | | 5.18 | 9.82 | 15 | 172 | 9 |
| | | 6.91 | 13.09 | 20 | 262 | 57 |
| | | 8.63 | 16.37 | 25 | 298 | 76 |
| | | 10.36 | 19.64 | 30 | 298 | 76 |
| | SAA 3 | 1.97 | 5.03 | 7 | 159 | 3 |
| | | 2.82 | 7.18 | 10 | 164 | 5 |
| | | 4.23 | 10.77 | 15 | 171 | 9 |
| | | 5.63 | 14.37 | 20 | 243 | 47 |
| | | 7.04 | 17.96 | 25 | 303 | 78 |
| | | 8.45 | 21.55 | 30 | 305 | 79 |
| | HJ-349- | 2.10 | 4.90 | 7 | 161 | 3 |
| | 46 | 3.00 | 7.00 | 10 | 161 | 4 |
| | | 4.50 | 10.50 | 15 | 166 | 6 |
| | | 6.00 | 14.00 | 20 | 168 | 7 |
| | | 7.50 | 17.50 | 25 | 166 | 6 |
| | | 9.00 | 21.00 | 30 | 176 | 12 |
| | | 10.50 | 24.50 | 35 | 196 | 22 |
| | | 12.00 | 28.00 | 40 | 205 | 27 |
| | | 15.00 | 35.00 | 50 | 265 | 58 |
| | | 18.00 | 42.00 | 60 | 307 | 81 |
| | SAA 4 | 3.19 | 3.81 | 7 | 166 | 6 |
| | | 4.56 | 5.44 | 10 | 158 | 2 |
| | | 6.84 | 8.16 | 15 | 162 | 4 |
| | | 9.12 | 10.88 | 20 | 224 | 37 |
| | | 11.40 | 13.60 | 25 | 296 | 75 |
| | | 13.68 | 16.32 | 30 | 296 | 74 |
| | PAA | 3.86 | 3.14 | 7 | 160 | 3 |
| | | 5.52 | 4.48 | 10 | 157 | 2 |
| | | 8.28 | 6.72 | 15 | 181 | 14 |
| | | 11.04 | 8.96 | 20 | 301 | 77 |
| | | 13.80 | 11.20 | 25 | 298 | 76 |
| | | 16.56 | 13.44 | 30 | 300 | 77 |
| | HJ-349- | 2.44 | 4.56 | 7 | 158 | 2 |
| | 90 | 3.48 | 6.52 | 10 | 161 | 3 |
| | | 5.22 | 9.78 | 15 | 165 | 6 |
| | | 6.96 | 13.04 | 20 | 166 | 6 |
| | | 8.70 | 16.30 | 25 | 179 | 13 |
| | | 10.44 | 19.56 | 30 | 253 | 52 |
| | HJ-349- | 2.73 | 4.27 | 7 | 164 | 5 |
| | 77 | 3.90 | 6.10 | 10 | 160 | 3 |
| | | 5.84 | 9.16 | 15 | 164 | 5 |
| | | 7.79 | 12.21 | 20 | 208 | 28 |
| | | 9.74 | 15.26 | 25 | 274 | 63 |
| | | 11.69 | 18.31 | 30 | 275 | 63 |
| | HJ-349- | 3.10 | 3.90 | 7 | 162 | 4 |
| | 76 | 4.42 | 5.58 | 10 | 156 | 1 |
| | | 6.64 | 8.36 | 15 | 161 | 3 |
| | | 8.85 | 11.15 | 20 | 157 | 1 |
| | | 11.06 | 13.94 | 25 | 157 | 2 |
| | | 13.27 | 16.73 | 30 | 158 | 2 |

| | | |
|---|---|---|
| Control | 154 | 0 |
| Stock | 344 | 100 |

HJ-349-90 is poly(2-acrylamido-2-methylpropane sulfonic acid/acrylic amide) (molar ratio: 7:3) synthesized by method similar with that in examples 11-12 except the amount of materials used.

TABLE 10

| | | Dosage | Dosage | | Mol % of | | |
|---|---|---|---|---|---|---|---|
| | | of | of | | 2-(methacryloyloxy)- | | |
| | | cationic | anionic | Total | ethyltrimethyl | Average | |
| Cationic | Anionic | polymer | polymer | dosage | ammonium | reactive silica | Inhibition |
| polymer | polymer | (ppm) | (ppm) | (ppm) | chloride in blends | (ppm) | (%) |
| HJ-349- | SAA 3 | 3.8 | 66.2 | 69.6 | 5.2 | 228 | 28 |
| 14 | | 6.76 | 132.4 | 139.2 | 5.2 | 279.5 | 56 |
| | | 10.14 | 198.6 | 198.6 | 5.2 | 307 | 71 |
| | | 2.3 | 76.7 | 79 | 3.2 | 226 | 27 |
| | | 4.6 | 153.4 | 158 | 3.2 | 263.5 | 48 |
| | | 6.9 | 230.1 | 237 | 3.2 | 286 | 60 |
| | SAA 1 | 4.79 | 52.2 | 56.98 | 5.3 | 167.5 | −5 |
| | | 9.58 | 104.4 | 113.96 | 5.3 | 273 | 53 |
| | | 14.37 | 156.6 | 170.94 | 5.3 | 282 | 58 |
| | | 3.43 | 65.25 | 68.68 | 3.0 | 171 | −3 |
| | | 6.86 | 130.5 | 137.36 | 3.0 | 247.5 | 39 |
| | | 10.29 | 195.75 | 206.04 | 3.0 | 272 | 52 |

| | | |
|---|---|---|
| Control | 177 | 0 |
| Stock | 359 | 100 |

TABLE 11

| | | Dose | | Dose | | | | |
|---|---|---|---|---|---|---|---|---|
| Bottle | | (ppm | | (ppm | ppm | % | Ave. | Final |
| No. | anionic polymer | active) | polyampholyte | active) | SiO₂ | Inhib. | % Inhib | pH |
| 1 | HJ-349-46 | 6.45 | HJ-349-25 | 8.55 | 335 | 82.7 | 80.7 | 7.40 |
| 2 | HJ-349-46 | 6.45 | HJ-349-25 | 8.55 | 328 | 78.7 | | 7.35 |
| 3 | Acumer ™ 1000 | 6.45 | HJ-349-25 | 8.55 | 328 | 78.7 | 76.4 | 7.50 |
| 4 | Acumer ™ 1000 | 6.45 | HJ-349-25 | 8.55 | 320 | 74.1 | | 7.35 |
| 5 | Acumer ™ 1100 | 6.45 | HJ-349-25 | 8.55 | 325 | 76.9 | 74.9 | 7.42 |
| 6 | Acumer ™ 1100 | 6.45 | HJ-349-25 | 8.55 | 318 | 72.9 | | 7.47 |
| 7 | Acumer ™ 2000 | 6.45 | HJ-349-25 | 8.55 | 328 | 78.7 | 80.1 | 7.47 |
| 8 | Acumer ™ 2000 | 6.45 | HJ-349-25 | 8.55 | 333 | 81.6 | | 7.37 |
| 9 | SAA 1 | 6.45 | HJ-349-25 | 8.55 | 333 | 81.6 | 79.3 | 7.50 |
| 10 | SAA 1 | 6.45 | HJ-349-25 | 8.55 | 325 | 76.9 | | 7.52 |
| 11 | SAA 2 | 6.45 | HJ-349-25 | 8.55 | 340 | 85.6 | 86.5 | 7.15 |
| 12 | SAA 2 | 6.45 | HJ-349-25 | 8.55 | 343 | 87.3 | | 7.16 |
| 13 | SAA 3 | 6.45 | HJ-349-25 | 8.55 | 340 | 85.6 | 86.5 | 7.17 |
| 14 | SAA 3 | 6.45 | HJ-349-25 | 8.55 | 343 | 87.3 | | 7.25 |
| 15 | Control | 0 | | | 200 | 4.9 | 191.5 | 7.35 |
| 16 | Control | 0 | | | 183 | −4.9 | | 7.72 |
| 17 | Stock | 0 | | | 365 | 100.0 | 365.0 | 11.50 |
| 18 | Stock | 0 | | | 365 | 100.0 | | 11.53 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of controlling silica scale in an aqueous system, comprising adding an effective amount of mixture of a first polymer and a second polymer into the aqueous system, wherein:
the first polymer and the second polymer each comprising at least one of a first structural unit derived from any of quaternary ammonium monomer, quaternary phosphonium monomer, and quaternary sulfonium monomer and a second structural unit derived from any of sulfonic acid, sulfuric acid, phosphoric acid, carboxylic acid and any salt thereof, the first polymer bearing a first net charge or being neutral, the second polymer bearing a second net charge opposite the first net charge or bearing positive net charge when the first polymer is neutral, the first structural unit being about 1-99 mol % of the mixture.

2. The method of claim 1, wherein the first polymer is a cationic polyelectrolyte and the second polymer is an anionic polyelectrolyte.

3. The method of claim 1, wherein the first polymer is a cationic polyelectrolyte and the second polymer is a nonionic polymer.

4. The method of claim 1, wherein the first polymer is a cationic polyelectrolyte and the second polymer is a combination of a nonionic polymer and an anionic polymer.

5. The method of claim 1, wherein the first polymer is a polyampholyte and the second polymer is a polyelectrolyte.

6. The method of claim 1, wherein the first and the second polymers are polyampholytes.

7. The method of claim 1, wherein the first and the second polymers are poly(2-(methacryloyloxy)-ethyltrimethyl ammonium chloride-co-2-acrylamido-2-methylpropane sulfonic acid) and wherein 2-(methacryloyloxy)-ethyltrimethyl ammonium chloride is from about 10 mol % to about 90 mol % of the mixture.

8. The method of claim 1, wherein the first polymer is poly(2-(methacryloyloxy)-ethyltrimethyl ammonium chloride-co-acrylic amide) and the second polymer is poly(2-acrylamido-2-methylpropane sulfonic acid-co-acrylic amide) and wherein 2-(methacryloyloxy)-ethyltrimethyl ammonium chloride is from about 30 mol % to about 70 mol % of the mixture.

9. The method of claim 1, wherein the first polymer is poly(2-(methacryloyloxy)-ethyltrimethyl ammonium chloride-co-2-acrylamido-2-methylpropane sulfonic acid) and the second polymer is selected from poly(2-acrylamido-2-methylpropane sulfonic acid), poly(acrylic acid), poly(acrylic acid/2-acrylamido-2-methylpropane sulfonic acid), poly(acrylic acid-co-1-allyoxy-2-hydroxy propyl sulfonate), poly(acrylic acid-co-1-allyoxy-polyethlyene oxide-sulfate-co-1-allyoxy-2-hydroxy propyl sulfonate) and poly(acrylic acid-co-1-allyoxy-polyethlyene oxide-sulfate).

10. The method of claim 9, wherein 2-(methacryloyloxy)-ethyltrimethyl ammonium chloride is from about 10 mol % to 60 mol % of the mixture.

11. The method of claim 1, wherein the first polymer is poly(2-(methacryloyloxy)-ethyltrimethyl ammonium chloride) and the second polymer is selected from poly(2-acrylamido-2-methylpropane sulfonic acid), poly(acrylic acid/2-acrylamido-2-methylpropane sulfonic acid), poly(acrylic acid), poly(acrylic acid-co-1-allyoxy-2-hydroxy propyl sulfonate), poly(acrylic acid-co-1-allyoxy-polyethlyene oxide-sulfate-co-1-allyoxy-2-hydroxy propyl sulfonate), poly(acrylic acid-co-1-allyoxy-polyethlyene oxide-sulfate), and poly(2-acrylamido-2-methylpropane sulfonic acid-co-acrylic amide).

12. The method of claim 11, wherein 2-(methacryloyloxy)-ethyltrimethyl ammonium chloride is from about 10 mol % to about 70 mol % of the mixture.

13. The method of claim 1, wherein the first polymer is poly(2-(methacryloyloxy)-ethyltrimethyl ammonium chloride-co-(ethylene glycol) methyl ether methacrylate) and the second polymer is poly(2-acrylamido-2-methylpropane sulfonic acid).

14. A method of inhibiting silica scale formation in water, said method comprising:
adding an effective amount of a polymer to a volume of water, wherein the polymer comprises:
a first structural unit derived from a quaternary ammonium monomer, a quaternary phosphonium monomer, or a quaternary sulfonium monomer, the first structural unit representing from about 30 to about 80 mol % of all monomer-derived structural units present in the polymer; and
a second structural unit derived from a sulfonic acid, a sulfuric acid, a phosphoric acid, or a salt thereof.

15. The method of claim 14, wherein the first structural unit derives from a monomer of formula: 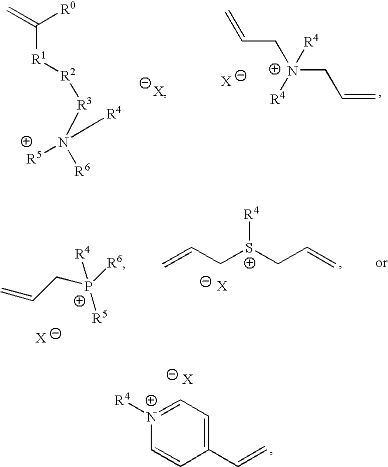
wherein R⁰ is H or an aliphatic radical; R¹ is C═O, an aromatic radical, a cycloaliphatic radical, or an aliphatic radical; R² is O, NH or an aliphatic radical; R³ is a straight or branched chain comprising 1-20 carbon atoms; R⁴, R⁵ and R⁶ are H, alkyl group comprising 1-5 carbon atoms, allyl, phenyl, cycloaliphatic or heteroaryl radical, respectively; and X is a charge-balancing counterion.

16. The method of claim 15, wherein X is halogen anion.

17. The method of claim 15, wherein X is monovalent or divalent anion.

18. The method of claim 14, wherein the first structural unit derives from at least one monomer selected from 2-(methacryloyloxy)-ethyltrimethyl ammonium chloride, 2-(acryloyloxyethyl)trimethylammonium chloride, 3-(acrylamidopropyl)trimethylammonium chloride, (vinylbenzyl)trimethylammonium chloride, 2-(acryloyloxyethyl)-N-benzyl-N,N-dimethylammonium chloride, 2-(methacryloyloxy)ethyltrimethylammonium methyl sulfate, 3-(methacrylamidopropyl)trimethylammonium chloride, and diallyldimethylammonium chloride.

19. The method of claim 14, wherein the second structural unit derives from a monomer selected from 2-acrylamido-2-methylpropane sulfonic acid, 3-(allyloxy)-2-hydroxypropane-1-sulfonic acid (sulfonate), 2-allyoxy-polyethlyene oxide-sulfate, and combinations thereof.

20. The method of claim 14, further comprising structural units derived from at least one monomer selected from diethyl 2-(methacryloyloxy) ethyl phosphate, bis[2-(methacryloyloxy)ethyl]phosphate, acrylamide, 2-hydroxyethyl methacrylate, N-(2-hydroxyethyl)acrylamide, poly(ethylene glycol) methyl ether methacrylate, poly(ethylene glycol) methyl ether acrylate, poly(ethylene glycol) ethyl ether methacrylate, poly(ethylene glycol) methacrylate, and 1-vinyl-2-pyrrolidinone.

21. The method of claim 14, wherein the first structural unit is present in an amount corresponding to from about 50 mol % to about 70 mol % of all monomer-derived structural units present in the polymer.

22. The method of claim 14, wherein the first structural unit is present in an amount corresponding to from about 55 to about 60 mol % of all monomer-derived structural units present in the polymer.

23. The method of claim 14, wherein the polymer is poly(2-(methacryloyloxy)-ethyltrimethyl ammonium chloride-co-2-acrylamido-2-methylpropane sulfonic acid).
